(19) United States
(12) Patent Application Publication
(10) Pub. No.: US 2024/0420858 A1
(43) Pub. Date: Dec. 19, 2024

(54) HIGH-PRECISION ANALYSIS METHOD FOR KEY THERMAL SAFETY PHENOMENA IN NUCLEAR REACTOR BASED ON PARTICLE METHOD

(71) Applicant: Xi'an Jiaotong University, Xi'an City (CN)

(72) Inventors: Wenxi TIAN, Xi'an City (CN); Ronghua CHEN, Xi'an City (CN); Kailun GUO, Xi'an City (CN); Kui ZHANG, Xi'An City (CN); Suizheng QIU, Xi'an City (CN); Guanghui SU, Xi'an City (CN)

(21) Appl. No.: 18/647,299

(22) Filed: Apr. 26, 2024

(30) Foreign Application Priority Data
Jun. 14, 2023 (CN) 202310706212.0

(51) Int. Cl. G21D 3/04; G06F 30/23; G06F 30/25; G06F 111/10; G06F 119/08; G21C 15/18

(52) U.S. Cl. CPC G21D 3/04; G06F 30/23; G06F 30/25; G21C 15/18; G06F 2111/10; G06F 2119/08

(57) ABSTRACT

A high-precision analysis method for key thermal safety phenomena in a nuclear reactor based on a particle method is provided. Fine complex geometric modeling is implemented based on a multi-resolution particle method. High-order discretization of control equations is implemented using a high-order particle discretization model. Key thermal-hydraulic, mechanical deformation, chemical reaction, and neutron physics phenomena can be analyzed. An implicit and explicit hybrid solving technique and an asynchronous marching algorithm are employed. The method of the present disclosure integrates the multi-resolution particle method, high-order discretization model, advanced solving and marching techniques, and comprehensive physical-mathematical model to achieve a comprehensive, fine, and efficient analysis of key thermal safety phenomena in a nuclear reactor, avoiding mesh distortion in the mesh approach, and significantly improving the precision, stability, calculation efficiency, and robustness of the particle method.

### CROSS REFERENCE TO RELATED APPLICATION

This patent application claims the benefit and priority of Chinese Patent Application No. 202310706212.0, filed with the China National Intellectual Property Administration on Jun. 14, 2023, the disclosure of which is incorporated by reference herein in its entirety as part of the present application.

### TECHNICAL FIELD

The present disclosure relates to the technical field of research on key thermal safety phenomena in nuclear reactors, and in particular, to a high-precision analysis method for key thermal safety phenomena in a nuclear reactor based on a particle method.

### BACKGROUND

The mechanism of thermal-hydraulic safety phenomena in nuclear reactors is complex. Under accident conditions, it can exhibit multiphase, large-deformation, and non-equilibrium complex physicochemical processes, including bubble growth and collapse, as well as slip and detachment during flow boiling of the in-heap coolant, fusion deformation and other complex dynamic behaviors, oxidation and eutectics, high-temperature creep, melting and solidification, and relocation processes during severe accidents in the reactor core. These multiphase coupled non-uniform dynamic evolution processes are extremely complex and difficult to accurately predict. Traditional system and sub-channel analysis models use dimensional reduction and numerous simplifications, resulting in low prediction accuracy. Numerical simulation methods based on mesh technology can hardly capture such multiphase, complex-free-surface, and large-deformation physicochemical processes due to mesh distortion. Severe accidents in nuclear reactors may cause significant economic losses and potential radioactive material leaks, polluting the surrounding environment and posing hazards to public health. Nuclear safety issues have become a fundamental prerequisite and important link in the development of nuclear power. Therefore, there is an urgent need to develop advanced numerical methods with independent intellectual property rights to accurately simulate and predict complex thermal-hydraulic safety phenomena in nuclear reactors.

### SUMMARY

In order to comprehensively understand the mechanistic analysis of complex thermal safety phenomena in a nuclear reactor and uncover potential mechanisms, on the basis of the mechanistic analysis of the complex thermal safety phenomena in the nuclear reactor, the present disclosure proposes a high-precision analysis method for key thermal safety phenomena in a nuclear reactor based on a particle method. The method implements fine geometric modeling through multi-resolution particles, employs a high-order particle discretization model to significantly improve discretization accuracy, and integrates thermal-hydraulic, mechanical deformation, chemical reaction, and neutron physics calculation for a comprehensive study, aiming to obtain crucial data of key thermal safety phenomena in a nuclear reactor. The present disclosure achieves analysis of key thermal safety phenomena in a nuclear reactor, providing essential foundations for the study of thermal-hydraulic safety characteristics in a nuclear power plant reactor.

To achieve the above objective, the present disclosure adopts the following technical solution:

A high-precision analysis method for key thermal safety phenomena in a nuclear reactor based on a particle method. The analysis method is designed to analyze key thermal safety phenomena in a nuclear reactor. Fine complex geometric modeling is implemented based on a multi-resolution particle method; high-order discretization of control equations is implemented using a high-order particle discretization model; key thermal-hydraulic, mechanical deformation, chemical reaction, and neutron physics phenomena can be analyzed; the implicit and explicit hybrid solving technique and asynchronous marching algorithm are employed. The method integrates the multi-resolution particle method, high-order particle discretization model, advanced solving and marching techniques, and comprehensive physical-mathematical models to achieve a comprehensive, fine, and efficient analysis of the key thermal safety phenomena in the nuclear reactor.

Overall calculation steps of the method are as follows:

step 1: fine modeling through the multi-resolution particle method to construct a particle geometric model, and defining types, properties, initial parameters, and boundary conditions for each particle;

step 2: calculation based on the multi-resolution particle method: calculating a particle action radius, particle number density, particle splitting and fusion processes for particles of different resolution;

step 3: calculating key operators using the high-order particle discretization model to support subsequent calculation;

step 4: performing thermal-hydraulic calculation on the particle geometric model for the key thermal safety phenomena in the nuclear reactor;

step 5: performing mechanical deformation calculation on the particle geometric model for the key thermal safety phenomena in the nuclear reactor;

step 6: performing chemical reaction calculation on the particle geometric model for the key thermal safety phenomena in the nuclear reactor;

step 7: performing neutron physics calculation on the particle geometric model for the key thermal safety phenomena in the nuclear reactor;

step 8: exchanging information among the thermal-hydraulic, mechanical deformation, chemical reaction, and neutron physics calculation, with different parts of the calculation being performed at different time steps, and when the calculation reaches the same time step, updating the information and providing new input parameters for each part of the calculation; and

step 9: calculation judgment and output: determining whether to end the calculation according to a calculation result; if not, returning to step 2; if yes, ending the calculation and outputting target data.

The key thermal safety phenomena in the nuclear reactor, as analysis targets, include complex key phenomena of coolant bubble dynamics in a nuclear power system and complex key phenomena of severe accidents in the nuclear power system. The complex key phenomena of coolant bubble dynamics in the nuclear power system include bubble growth and collapse, slip and detachment, and fusion deformation during coolant flow boiling in the nuclear reactor; the complex key phenomena of severe accidents in the nuclear power system include oxidation and eutectics, high-temperature creep, melting and solidification, and relocation processes during severe accidents in a reactor core.

During the fine modeling through the multi-resolution particle method, the particle geometric model is constructed by applying particles of different sizes to the same geometric object. Small-size particles are used for modeling in local key positions and large-size particles are used for modeling in other positions, to restore fine structural characteristics of key parts and significantly reduce the amount of computation; during analysis, particle sizes are changed according to computation requirements; large-size particles are transformed into small-size particles when moving to the local key positions, and small-size particles are transformed into large-size particles when moving to the other positions.

The calculation based on the multi-resolution particle method is performed on the basis of the particle geometric model constructed through the multi-resolution particle method, and specifically includes the following steps:

step 1: calculating action ranges for particles of different sizes, where for a particle at an interface of two particles of different sizes, an effective particle action radius rₑ is an average value of rₑ of the two particles:

$${r}_{e} = \frac{{r}_{e , i} + {r}_{e , j}}{2} \qquad formula ( 1 )$$

where:

rₑ represents the effective particle action radius (m);

r_{e,i} represents a particle action radius of particle i, (m);

r_{e,j} represents a particle action radius of particle j, (m); and

the particle action radius of the particle is n times the particle size, with n ranging from 2 to 4;

step 2: calculating a multi-resolution particle number density, where a particle quantity within an action range under a same-sized initial distribution is calculated first, as shown in formula (2):

$$< N {>}_{i} = \{ \begin{matrix}{( \frac{{r}_{e}}{{l}_{0}} )}^{2} π & 2 D \\ \frac{4}{3} {( \frac{{r}_{e}}{{l}_{0}} )}^{3} π & 3 D\end{matrix} \qquad formula ( 2 )$$

where:

<N>ᵢ represents the particle quantity within the action range under the same-sized initial distribution;

l₀ represents a particle radius (m); and

π represents Pi;

for an action range under a variable-sized particle distribution, when the particle radius is k times the particle radius of the action range under the same-sized initial distribution, a particle quantity within the action range under the variable-sized particle distribution is calculated using formula (3):

$$< {N}_{MR} {>}_{i} = < N {>}_{i} \times {( \frac{1 + k}{2 k} )}^{2} \qquad ( 3 )$$

where:

<N_{MR}>ᵢ represents the particle quantity within the action range under the variable-sized particle distribution; and

k represents a ratio of the particle radius in the action range under the variable-sized particle distribution to the particle radius in the action range under the same-sized initial distribution;

in order to eliminate changes caused by action range variations, a correction factor is defined, as shown in formula (4):

$${s}_{ij} = {( \frac{2 k}{1 + k} )}^{d} \qquad formula ( 4 )$$

where:

Sᵢⱼ represents the correction factor for a multi-resolution action ranges; and

d represents spatial dimensionality;

the multi-resolution particle number density is calculated using formula (5):

$${n}_{MR , i} = {\sum }_{j} ( {s}_{ij} {w}_{ij} ) \qquad formula ( 5 )$$

where:

n_{MR,i} represents a multi-resolution particle number density of particle i; and

wᵢⱼ represents a kernel function value between particle i and particle j;

step 3: particle splitting: when particles enter a high-resolution area, each particle continuously splits into two particles, until the particle size is smaller than a target size; when a large mother splits into two small child particles, intensity quantities of the child particles, such as density and speed, inherit values from the mother particle, while other extensive quantities, such as mass, are set to half of values of the mother particle; in order to avoid as much as possible the split particles from overlapping with other particles, during selection of a splitting direction, a particle closest to the mother particle is found first, and then the mother particle is split along a direction perpendicular to a line connecting the closest particle and the mother particle; a particle does not need to be split when there are no other particles in the action range of the particle; and

step 4: particle fusion: when a small-sized particle enters a low-resolution area, a closest neighboring particle is searched for; when the neighboring particle is of a same type, fusion occurs, until a size exceeds the target size; sizes of two particles in the fusion are not necessarily the same, and a diameter of a new particle resulting from fusion of a particle with a diameter l₁ and a particle with a diameter l₂ is \sqrt{l₁²+l₂²} a velocity and a pressure of the new particle are set to mass-weighted average values of velocities and pressures of the original particles, while mass of the new particle is set to a sum of mass of the original particles.

A form of the high-order particle discretization model is given by formula (6) to formula (13); this model discretizes gradient, divergence, and Laplacian terms in the control equations; the control equations include all control equations in the thermal-hydraulic, mechanical deformation, chemical reaction, and neutron physics calculation.

$$D {ϕ}_{i} = {HMb}_{i} \qquad formula ( 6 )$$

$$D = {[ \begin{matrix}\frac{\partial }{\partial x} & \frac{\partial }{\partial y} & \frac{\partial }{\partial z} & \frac{\partial }{\partial {x}^{2}} & \frac{\partial }{\partial {y}^{2}} & \frac{\partial }{\partial {z}^{2}} & \frac{{\partial }^{2}}{\partial x \partial y} & \frac{{\partial }^{2}}{\partial x \partial z} & \frac{{\partial }^{2}}{\partial y \partial z}\end{matrix} ]}^{T} \qquad formula ( 7 )$$

$$H = diag ( \begin{matrix}\frac{1}{{n}^{0}} & \frac{1}{{n}^{0}} & \frac{1}{{n}^{0}} & \frac{2}{{n}^{0} {l}_{0}} & \frac{2}{{n}^{0} {l}_{0}} & \frac{2}{{n}^{0} {l}_{0}} & \frac{1}{{n}^{0} {l}_{0}} & \frac{1}{{n}^{0} {l}_{0}} & \frac{1}{{n}^{0} {l}_{0}}\end{matrix} ) \qquad formula ( 8 )$$

$${M}^{- 1} = {\sum }_{j \neq i} \frac{{w}_{ij} {p}_{ij} ⊗ {p}_{ij}}{{n}^{0}} \qquad formula ( 9 )$$

$${b}_{i} = {\sum }_{j \neq i} {w}_{ij} {ϕ}_{ij} {p}_{ij} \qquad formula ( 10 )$$

When particle j is an internal particle or a Dirichlet boundary:

$${p}_{ij} = {[ \begin{matrix}\frac{{x}_{ij}}{{r}_{ij}} & \frac{{y}_{ij}}{{r}_{ij}} & \frac{{z}_{ij}}{{r}_{ij}} & \frac{{x}_{ij}^{2}}{{l}_{0} {r}_{ij}} & \frac{{y}_{ij}^{2}}{{l}_{0} {r}_{ij}} & \frac{{z}_{ij}^{2}}{{l}_{0} {r}_{ij}} & \frac{{x}_{ij} {y}_{ij}}{{l}_{0} {r}_{ij}} & \frac{{x}_{ij} {z}_{ij}}{{l}_{0} {r}_{ij}} & \frac{{y}_{ij} {z}_{ij}}{{l}_{0} {r}_{ij}}\end{matrix} ]}^{T} \qquad formula ( 11 )$$

When particle j is a Neumann boundary:

$${p}_{ij} = {[ \begin{matrix}{n}_{x} & {n}_{y} & {n}_{z} & \frac{2 {n}_{x} {x}_{ij}}{{l}_{0}} & \frac{2 {n}_{y} {y}_{ij}}{{l}_{0}} & \frac{2 {n}_{z} {z}_{ij}}{{l}_{0}} & \frac{{n}_{y} {x}_{ij} + {n}_{x} {y}_{ij}}{{l}_{0}} & \frac{{n}_{z} {x}_{ij} + {n}_{x} {z}_{ij}}{{l}_{0}} & \frac{{n}_{z} {y}_{ij} + {n}_{y} {z}_{ij}}{{l}_{0}}\end{matrix} ]}^{T} \qquad formula ( 12 )$$

$${ϕ}_{ij} = \{ \begin{matrix}\frac{{ϕ}_{j} - {ϕ}_{i}}{{r}_{ij}} & j ∈ Internal particle or Dirichlet boundary \\ \frac{\partial {ϕ}_{j}}{\partial {n}_{j}} & j ∈ Neumann boundary\end{matrix} \qquad ( 13 )$$

where:

D represents a differential operator vector;

$$\frac{\partial }{\partial x} , \frac{\partial }{\partial y} , and \frac{\partial }{\partial z}$$

represent first-order partial derivatives in x, y, and z directions, respectively;

$$\frac{\partial }{\partial {x}^{2}} , \frac{\partial }{\partial {y}^{2}} , and \frac{\partial }{\partial {z}^{2}}$$

represent second-order partial derivatives in xx, yy, and zz directions,

respectively;

$$\frac{{\partial }^{2}}{\partial x \partial y} , \frac{{\partial }^{2}}{\partial x \partial z} , and \frac{{\partial }^{2}}{\partial y \partial z}$$

represent second-order partial derivatives in xy, xz, and yz directions, respectively;

H represents a coefficient matrix of the high-order discretization model;

n⁰ represents an initial particle number density;

M represents a gradient matrix of the high-order discretization model;

bᵢ represents a source term vector of the high-order particle discretization model for particle i;

Pᵢⱼ represents a position gradient vector between particle i and particle j in the high-order discretization model;

xᵢⱼ, yᵢⱼ, and zᵢⱼ represent distances between particle i and particle j in the x, y, and z directions, respectively;

rᵢⱼ represents a distance between particle i and particle j;

nⱼ represents a normal vector of particle j;

nₓ, n_{y}, and n_{z} represent components of the normal vector of particle j in the x, y, and z directions, respectively;

ϕᵢⱼ represents a parameter gradient vector between particle i and particle j in the high-order discretization model;

ϕⱼ represents a parameter scalar value of particle j; and

ϕᵢ represents a parameter scalar value of particle i.

The thermal-hydraulic calculation of the key thermal safety phenomena in the nuclear reactor is established based on the key thermal safety phenomena in the nuclear reactor, where calculation steps are as follows:

step 1: calculating incompressible fluid mass and momentum conservation equations as shown in formula (14) and formula (15), where operators in the formulas are discretized using the high-order particle discretization model into algebraic equations; viscosity and pressure terms in the momentum conservation equation are solved implicitly, while surface tension and gravity terms are solved explicitly;

$$\frac{D ρ}{Dt} + ρ ∇ \cdot u = 0 \qquad formula ( 14 )$$

$$ρ \frac{du}{dt} = - ∇ P + μ {∇}^{2} u + ρ f + ρ g \qquad formula ( 15 )$$

where:

ρ represents density (kg/m³);

u represents a velocity vector (m);

t represents time(s);

P represents pressure (Pa);

μ represents dynamic viscosity (Pa·s);

f represents a surface tension vector (N); and

g represents a gravity acceleration vector (m/s²);

step 2: calculating an energy conservation equation as shown in formula (16), where operators in the formula are discretized into algebraic equations using the high-order particle discretization model, and are solved implicitly, and a heat source uses heat density to provide Neumann boundary conditions;

$$ρ \frac{\partial h}{\partial t} = {∇}^{2} {κ}_{T} T + {Q}_{ν} \qquad formula ( 16 )$$

where:

h represents an enthalpy (J/kg);

κT represents thermal conductivity (W/(m·K));

T represents temperature (K);

Qᵥ represents the heat source (W/m³);

radiative heat transfer is included in the heat source, calculated using formula (17) to formula (18):

$${Q}_{r} = \frac{{h}_{r} {A ( {T}_{i} - {T}_{e n v} )}^{4}}{{l}_{0}^{3}} \qquad formula ( 17 )$$

$${h}_{r} = \frac{{σ}_{s t e f}}{1 / {ε}_{i} + 1 / {ε}_{e n v} - 1} ( {T}_{i}^{2} + {T}_{e n v}^{2} ) ( {T}_{i} - {T}_{e n v} ) \qquad formula ( 18 )$$

where:

Qᵣ represents the heat source of the radiative heat transfer (W/m³);

hᵣ represents radiative heat transfer coefficient (W/(m²·K));

σ_{stef} represents a Stefan-Boltzmann constant;

εᵢ represents radiative emissivity of free surface particle i;

εₑₙᵥ represents radiative emissivity of surrounding environment;

Tₑₙᵥ represents temperature of surrounding environment (K);

A represents a radiative heat transfer area (m²);

temperature is calculated using formula (19):

$$T = \{ \begin{matrix}{T}_{s} + \frac{h - {h}_{s}}{{c}_{p}} & h < {h}_{s} \\ {T}_{s} + \frac{( h - {h}_{s} ) ( {T}_{l} - {T}_{s} )}{{h}_{l} - {h}_{s}} & {h}_{s} \leq h \leq {h}_{l} \\ {T}_{l} + \frac{h - {h}_{l}}{{c}_{p}} & {h}_{l} < h\end{matrix} \qquad ( 19 )$$

where:

Tₛ and Tₗ represent a solidus temperature and a liquidus temperature (K), respectively;

hₛ and hₗ represent enthalpies (J/kg) corresponding to the solidus temperature and the liquidus temperature, respectively;

cₚ represents Specific heat capacity at constant pressure (J/(kg·K));

a solid fraction is calculated using formula (20):

$$r = \{ \begin{matrix}1 & h < {h}_{s} \\ \frac{{h}_{l} - h}{{h}_{l} - {h}_{s}} & {h}_{s} \leq h \leq {h}_{l} \\ 0 & {h}_{l} < h\end{matrix} \qquad formula ( 20 )$$

where:

γ represents the solid fraction.

The analysis of key thermal-hydraulic phenomena applies to gas flow heat transfer and boiling processes. When boiling occurs, due to a significant difference in gas-liquid density ratio, a particle generation method is used to analyze the boiling process. The particle generation method involves generating small-sized particles around a target particle based on an enthalpy rise when the target particle reaches a boiling point, where properties of the small-sized particles mimic a gaseous state of the target particle, and mass of the small-sized particles is determined based on a boiling rate. After the small-sized particles are generated, mass of the target particle changes. A particle generation process employs splitting and fusion of the multi-resolution particle method.

For fluid media with large density and viscosity ratios, smoothed density values are calculated as shown in formula (21) and formula (22):

$${ρ}_{g , i} = \frac{1}{{\sum }_{j} {G}_{i j}} {\sum }_{j} ( {ρ}_{j} + \frac{18 {r}_{i j}}{{r}_{e}^{2}} ( \frac{{\sum }_{j} {r}_{i j} {ρ}_{j} {G}_{i j} \times {\sum }_{j} {G}_{i j} - {\sum }_{j} {ρ}_{j} {G}_{i j} \times {\sum }_{j} {r}_{i j} {G}_{i j}}{{( {\sum }_{j} {G}_{i j} )}^{2}} ) ) {G}_{i j} \qquad formula ( 21 )$$

$$〈 μ \cdot {∇}^{2} u 〉 = \frac{1}{{n}_{G}^{0}} {\sum }_{j} \frac{2 {μ}_{i} {μ}_{j}}{{μ}_{i} + {μ}_{j}} ( \frac{36}{{r}_{e}^{2}} + \frac{324 {r}_{i j}^{2}}{{r}_{e}^{4}} ) {u}_{i j} {G}_{i j} \qquad formula ( 22 )$$

where:

ρ_{g,i} represents a smoothed density value of particle i (kg/m³);

Gᵢⱼ represents a Gaussian kernel function between particle i and particle j;

ρⱼ represents a density of particle j (kg/m³);

n_{G}⁰ represents an initial particle number density calculated using the Gaussian kernel function; and

μᵢ and μⱼ represent dynamic viscosities of particle i and particle j, (Pa·s).

The mechanical deformation calculation of the key thermal safety phenomena in the nuclear reactor is established based on the key thermal safety phenomena in the nuclear reactor, including elastic deformation, plastic deformation, creep, thermal expansion, fracture, and solid collision, where calculation steps are as follows:

an overall strain relationship is given by formula (23):

$$[ d ε ] = [ d {ε}^{E} ] + [ d {ε}^{P} ] + [ d {ε}^{C} ] + [ d {ε}^{T} ] \qquad ( 23 )$$

where:

[dε] represents total strain;

[dε^{E}] represents elastic strain;

[dε^{P}] represents plastic strain;

[dε^{C}] represents creep strain; and

[dε^{T}] represents thermal expansion strain.

Stress-strain calculation is performed using formula (24) to formula (25); a stress-strain relationship of a material is obtained considering a constitutive equation of the material, where differential terms in the formulas are discretized using the high-order particle discretization model:

$$\frac{D {u}_{α}}{D t} = \frac{1}{ρ} \frac{\partial {σ}_{αβ}}{\partial {x}_{β}} \qquad formula ( 24 )$$

$${ε}_{αβ} = \frac{1}{2} ( \frac{\partial {u}_{α}}{\partial {x}_{β}} + \frac{\partial {u}_{β}}{\partial {x}_{α}} ) \qquad formula ( 25 )$$

where:

u_{α} and u_{β} represents component of a velocity in α and β directions (m/s);

σ_{αβ} represents an αβ component of a total stress tensor (N/m²);

ε_{αβ} represents an αβ component of a total strain tensor; and

x_{α} and x_{β} represent components of a Position in α and β directions (m).

Fracture is determined based on stress-strain limits. When stress of a particle exceeds a stress limit or strain of a particle exceeds a strain limit, a relationship between particles is considered broken. Only an effect of solid collision forces between particles is calculated, and no mechanical equation calculation within solid is performed.

The chemical reaction calculation of the key thermal safety phenomena in the nuclear reactor is established based on the key thermal safety phenomena in the nuclear reactor. The chemical reaction calculation uses two modes, which are based on molecular diffusion and chemical reaction rates, respectively. Molecular diffusion is calculated based on formula (26). Substance property changes and chemical reaction rates are obtained from chemical reaction equations and a chemical reaction database. Particle splitting and particle fusion are employed to obtain particle changes before and after chemical reactions.

$${J}_{A} = - {D}_{A} \frac{d {c}_{A}}{d y} \qquad formula ( 26 )$$

where:

J_{A} represents a diffusion flux of component A (mol (m²·s));

D_{A} represents a diffusion coefficient of component A (m²/s); and

c_{A} represents a molar concentration of component A (mol/m³).

The neutron physics calculation of the key thermal phenomena in the nuclear reactor is established based on the key thermal safety phenomena in the nuclear reactor. A Boltzmann transport equation using a multi-group approximation SN difference method is given by formula (27):

$$Ω \cdot ∇ ϕ ( r , Ω , {E}_{n} ) + {\sum }_{t} ϕ ( r , Ω , {E}_{n} ) = \int \int {\sum }_{s} ( r , {Ω}^{′} , {E}_{n}^{r} \to Ω , {E}_{n} ) ϕ ( r , {Ω}^{′} , {E}_{n}^{′} ) d {Ω}^{′} {dE}_{n}^{′} + \frac{χ ( r , {E}_{n} )}{4 π} \int \int v {\sum }_{f} ( r , {Ω}^{′} , {E}_{n}^{′} \} ϕ ( r , {Ω}^{′} , {E}_{n}^{′} ) d {Ω}^{′} {dE}_{n}^{′} + \frac{Q ( r , {E}_{n} )}{4 π} \qquad formula ( 27 )$$

where:

Ω represents a direction vector;

Ω′ represents another direction vector, which is different from Ω;

ϕ(r,Ω, Eₙ) represents a neutron angular flux density when the input is r,Ω, Eₙ;

ϕ(r,Ω′,Eₙ′) represents a neutron angular flux density when the input is r,Ω′,Eₙ′;

Σᵢ represents a total neutron cross-section;

Q(r,Eₙ) represents neutron source strength;

Eₙ represents neutron energy;

Eₙ′ represents another neutron energy, which is different from Eₙ;

Σₛ(r,Ω′, Eₙ′→ΩEₙ) represents a scattering cross-section;

X(r,Eₙ) represents a fission spectrum;

v represents the number of neutrons released per fission; and

Σ_{f}(r,Ω′,Eₙ′) represents a neutron fission cross-section.

The implicit and explicit hybrid solving technique means using explicit solving for the mechanical deformation calculation and the chemical reaction calculation, while using implicit solving for the thermal-hydraulic calculation and the neutron physics calculation. The asynchronous marching algorithm means that implicit solving, with a small time step limit, uses a large time step, and explicit solving, with strict time step requirements, needs to use a small time step. The time step limit is determined by numerical stability conditions, and different calculation models adopt different time steps, with a multiple relationship between time steps. When all calculations advance to the same time step, information is transferred, and data is updated. Implicit solving breaks through the time step limit, and combined with the asynchronous marching algorithm, significantly reduces computational costs and improves analysis efficiency.

The present disclosure provides a solution for the analysis of key thermal safety phenomena in a nuclear reactor and offers critical evidence for the study of key thermal safety characteristics in nuclear power plants.

Compared with the prior art, the present disclosure has the following advantages:

The high-precision analysis method for key thermal safety phenomena in a nuclear reactor based on a particle method according to the present disclosure comprehensively considers key thermal-hydraulic, mechanical deformation, chemical reaction, and neutron physics factors of the key thermal safety phenomena in the nuclear reactor. Fine complex geometric modeling is implemented based on a multi-resolution particle method; high-order discretization of control equations is implemented using a high-order particle discretization model; thermal-hydraulic, mechanical deformation, chemical reaction, and neutron physics calculations are employed; the implicit and explicit hybrid solving technique and asynchronous marching algorithm are employed. The method integrates the multi-resolution particle method, high-order particle discretization model, advanced solving and marching techniques, and comprehensive physical-mathematical model to achieve a comprehensive, fine, and efficient analysis of key thermal safety phenomena in a nuclear reactor, avoiding mesh distortion in the mesh approach, and significantly improving the precision, stability, calculation efficiency, and robustness of the particle method.

### BRIEF DESCRIPTION OF THE DRAWINGS

FIG. 1 is a flowchart of a high-precision analysis method for key thermal safety phenomena in a nuclear reactor based on a particle method according to the present disclosure.

### DETAILED DESCRIPTION OF THE EMBODIMENTS

The present disclosure will be further described below in conjunction with the accompanying drawings and specific embodiments.

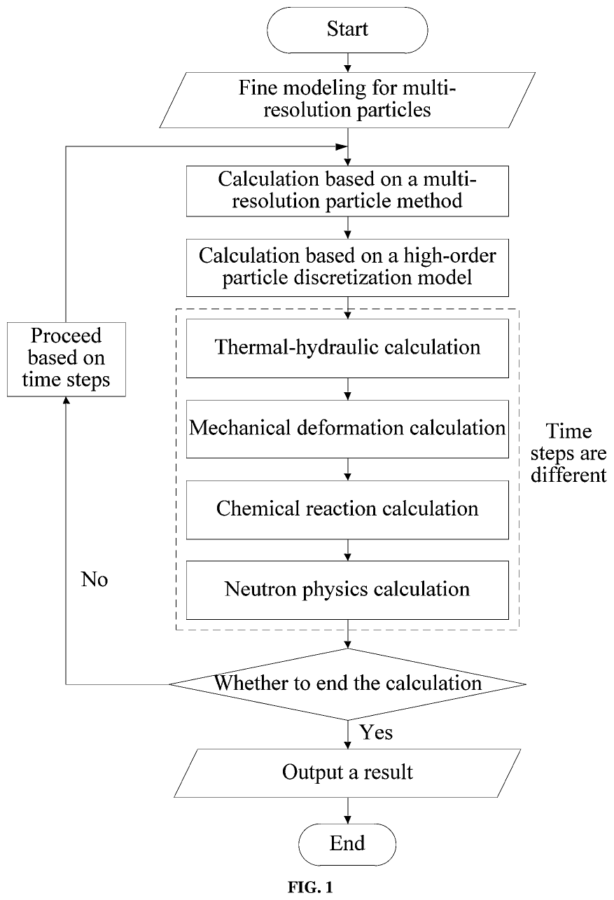

The high-precision analysis method for key thermal safety phenomena in a nuclear reactor based on a particle method according to the present disclosure, as shown in FIG. 1, is introduced using the example of a high-temperature melting process analysis of a single fuel rod in a typical pressurized water reactor under simplified conditions. The steps are as follows:

Step 1: Fine modeling for multi-resolution particles: based on a single fuel rod in a typical pressurized water reactor, construct a particle geometric model, where particles with a radius of 0.5 mm are used for a core, particles with a radius of 0.1 mm are used for a cladding, and particles with a radius of 1 mm are used for support elements; the fuel rod is in an exposed state without additional stress or strain, the core is set as an internal heat source, and the internal heat source is determined by decay power calculation.

Step 2: Calculation based on a multi-resolution particle method: calculate a particle action radius, particle number density, particle splitting and fusion processes for particles of different resolutions, where when the cladding melts, a single cladding particle continuously splits into 8 particles to ensure a tightly supported fluid neighbor particle domain.

Step 3: Calculate key operators using the high-order particle discretization model.

Step 4: Perform thermal-hydraulic calculation on the particle geometric model for key thermal safety phenomena in a nuclear reactor: the entire process involves calculating heat transfer phase change and flow fields, and before the fuel rod heats up, only the heat transfer process is calculated.

Step 5: Perform mechanical deformation calculation on the particle geometric model for the key thermal safety phenomena in the nuclear reactor: thermal creep and thermal expansion of the fuel rod during the heating process are considered; when the temperature reaches a specific level, and material properties change, and elastic and plastic deformations occur; a fracture process is calculated when stress reaches a specific value.

Step 6: Perform chemical reaction calculation on the particle geometric model for the key thermal safety phenomena in the nuclear reactor: a eutectic reaction between ZrO₂ and UO₂ is calculated.

Step 7: Perform neutron physics calculation on the particle geometric model for the key thermal safety phenomena in the nuclear reactor; and calculate a thermal power level based on initial conditions.

Step 8: Exchange information among the thermal-hydraulic, mechanical deformation, chemical reaction, and neutron physics calculation, with different parts of the calculation being performed at different time steps, and when the calculation reaches the same time step, update the information and provide new input parameters for each part of the calculation.

Step 9: Calculation judgment and output: determine whether to end the calculation according to a calculation result, namely, whether the fuel rod is completely melted and the molten material is fully expelled from the calculation domain; if not, return to step 2; if yes, end the calculation and output target data.

What is claimed is:

1. A high-precision analysis method for key thermal safety phenomena in a nuclear reactor based on a particle method, wherein the analysis method is designed to analyze key thermal safety phenomena in a nuclear reactor; fine complex geometric modeling is implemented based on a multi-resolution particle method; high-order discretization of control equations is implemented using a high-order particle discretization model; key thermal-hydraulic, mechanical deformation, chemical reaction, and neutron physics phenomena are analyzed; an implicit and explicit hybrid solving technique and an asynchronous marching algorithm are employed; the analysis method integrates the multi-resolution particle method, high-order particle discretization model, advanced solving and marching techniques, and comprehensive physical-mathematical models to achieve a comprehensive, fine, and efficient analysis of the key thermal safety phenomena in the nuclear reactor;
overall calculation steps of the method are as follows:
step 1: fine modeling through the multi-resolution particle method to construct a particle geometric model, and defining types, properties, initial parameters, and boundary conditions for each particle;
step 2: calculation based on the multi-resolution particle method: calculating a particle action radius, particle number density, particle splitting and fusion processes for particles of different resolution;
step 3: calculating key operators using the high-order particle discretization model to support subsequent calculation;
step 4: performing thermal-hydraulic calculation on the particle geometric model for the key thermal safety phenomena in the nuclear reactor;
step 5: performing mechanical deformation calculation on the particle geometric model for the key thermal safety phenomena in the nuclear reactor;
step 6: performing chemical reaction calculation on the particle geometric model for the key thermal safety phenomena in the nuclear reactor;
step 7: performing neutron physics calculation on the particle geometric model for the key thermal safety phenomena in the nuclear reactor;
step 8: exchanging information among the thermal-hydraulic, mechanical deformation, chemical reaction, and neutron physics calculation, with different parts of the calculation being performed at different time steps, and when the calculation reaches the same time step, updating the information and providing new input parameters for each part of the calculation; and
step 9: calculation judgment and output: determining whether to end the calculation according to a calculation result; if not, returning to step 2; if yes, ending the calculation and outputting target data.

2. The high-precision analysis method for key thermal safety phenomena in a nuclear reactor based on a particle method according to claim 1, wherein the key thermal safety phenomena in the nuclear reactor, as analysis targets, comprise complex key phenomena of coolant bubble dynamics in a nuclear power system and complex key phenomena of severe accidents in the nuclear power system; the complex key phenomena of coolant bubble dynamics in the nuclear power system comprise bubble growth and collapse, slip and detachment, and fusion deformation during coolant flow boiling in the nuclear reactor; the complex key phenomena of severe accidents in the nuclear power system comprise oxidation and eutectics, high-temperature creep, melting and solidification, and relocation processes during severe accidents in a reactor core.

3. The high-precision analysis method for key thermal safety phenomena in a nuclear reactor based on a particle method according to claim 1, wherein during the fine modeling through the multi-resolution particle method, the particle geometric model is constructed by applying particles of different sizes to a same geometric object; small-size particles are used for modeling in local key positions and large-size particles are used for modeling in other positions, to restore fine structural characteristics of key parts and significantly reduce the amount of computation; during analysis, particle sizes are changed according to computation requirements; large-size particles are transformed into small-size particles when moving to the local key positions, and small-size particles are transformed into large-size particles when moving to the other positions;
the calculation based on the multi-resolution particle method is performed on the basis of the particle geometric model constructed through the multi-resolution particle method, and specifically comprises the following steps:
step 1: calculating action ranges for particles of different sizes, wherein for a particle at an interface of two particles of different sizes, an effective particle action radius rₑ is an average value of rₑ of the two particles:
$${r}_{e} = \frac{{r}_{e , i} + {r}_{e , j}}{2} \qquad formula ( 1 )$$
wherein:
rₑ represents the effective particle action radius (m);
r_{e,i} represents a particle action radius of particle i, (m);
r_{e,j} represents a particle action radius of particle j, (m); and
the particle action radius of the particle is n times the particle size, with n ranging from 2 to 4;
step 2: calculating a multi-resolution particle number density, wherein a particle quantity within an action range under a same-sized initial distribution is calculated first, as shown in formula (2):
$$< N {>}_{i} = \{ \begin{matrix}{( \frac{{r}_{e}}{{l}_{0}} )}^{2} π & 2 D \\ \frac{4}{3} {( \frac{{r}_{e}}{{l}_{0}} )}^{3} π & 3 D\end{matrix} \qquad formul a ( 2 )$$
wherein:
<N>ᵢ represents the particle quantity within the action range under the same-sized initial distribution;
l₀ represents a particle radius (m); and
π represents Pi;
for an action range under a variable-sized particle distribution, when the particle radius is k times the particle radius of the action range under the same-sized initial distribution, a particle quantity within the action range under the variable-sized particle distribution is calculated using formula (3):
$$< {N}_{M R} {>}_{i} = < N {>}_{i} \times {( \frac{1 + k}{2 k} )}^{2} \qquad ( 3 )$$
wherein:
<N_{MR}>ᵢ represents the particle quantity within the action range under the variable-sized particle distribution; and
k represents a ratio of the particle radius in the action range under the variable-sized particle distribution to the particle radius in the action range under the same-sized initial distribution;
in order to eliminate changes caused by action range variations, a correction factor is defined, as shown in formula (4):
$${s}_{ij} = {( \frac{2 k}{1 + k} )}^{d} \qquad formula ( 4 )$$
wherein:
Sᵢⱼ represents the correction factor for a multi-resolution action ranges; and
d represents spatial dimensionality;
the multi-resolution particle number density is calculated using formula (5):
$${n}_{M R , i} = {\sum }_{j} ( {s}_{i j} {w}_{i j} ) \qquad formula ( 5 )$$
wherein:
n_{MR,i} represents a multi-resolution particle number density of particle i; and
wᵢⱼ represents a kernel function value between particle i and particle j;
step 3: particle splitting: when particles enter a high-resolution area, each particle continuously splits into two particles, until the particle size is smaller than a target size; when a large mother splits into two small child particles, intensity quantities of the child particles inherit values from the mother particle, while other extensive quantities are set to half of values of the mother particle; in order to avoid as much as possible the split particles from overlapping with other particles, during selection of a splitting direction, a particle closest to the mother particle is found first, and then the mother particle is split along a direction perpendicular to a line connecting the closest particle and the mother particle; a particle does not need to be split when there are no other particles in the action range of the particle; and
step 4: particle fusion: when a small-sized particle enters a low-resolution area, a closest neighboring particle is searched for; when the neighboring particle is of a same type, fusion occurs, until the particle size exceeds the target size; sizes of two particles in the fusion are not necessarily the same, and a diameter of a new particle resulting from fusion of a particle with a diameter l₁ and a particle with a diameter l₂ is \sqrt{l₁²+l₂²}; a velocity and a pressure of the new particle are set to mass-weighted average values of velocities and pressures of the original particles, while mass of the new particle is set to a sum of mass of the original particles.

4. The high-precision analysis method for key thermal safety phenomena in a nuclear reactor based on a particle method according to claim 1, wherein a form of the high-order particle discretization model is given by formula (6) to formula (13); the model discretizes gradient, divergence, and Laplacian terms in the control equations; the control equations comprise all control equations in the thermal-hydraulic, mechanical deformation, chemical reaction, and neutron physics calculation.
$$D {ϕ}_{i} = H M {b}_{i} \qquad formula ( 6 )$$
$$D = {[ \begin{matrix}\frac{\partial }{\partial x} & \frac{\partial }{\partial y} & \frac{\partial }{\partial z} & \frac{\partial }{\partial {x}^{2}} & \frac{\partial }{\partial {y}^{2}} & \frac{\partial }{\partial {z}^{2}} & \frac{{\partial }^{2}}{\partial x \partial y} & \frac{{\partial }^{2}}{\partial x \partial z} & \frac{{\partial }^{2}}{\partial y \partial z}\end{matrix} ]}^{T} \qquad formula ( 7 )$$
$$H = diag ( \frac{1}{{n}^{0}} \frac{1}{{n}^{0}} \frac{1}{{n}^{0}} \frac{2}{{n}^{0} {l}_{0}} \frac{2}{{n}^{0} {l}_{0}} \frac{2}{{n}^{0} {l}_{0}} \frac{1}{{n}^{0} {l}_{0}} \frac{1}{{n}^{0} {l}_{0}} \frac{1}{{n}^{0} {l}_{0}} ) \qquad formula ( 8 )$$
$${M}^{- 1} = {\sum }_{j \neq i} \frac{{w}_{i j} {p}_{i j} ⊗ {p}_{i j}}{{n}^{0}} \qquad formula ( 9 )$$
$${b}_{i} = {\sum }_{j \neq i} {w}_{ij} {ϕ}_{ij} {p}_{ij} \qquad formula ( 10 )$$
when particle j is an internal particle or a Dirichlet boundary:
$${p}_{i j} = {[ \begin{matrix}\frac{{x}_{ij}}{{r}_{ij}} & \frac{{y}_{ij}}{{r}_{ij}} & \frac{{z}_{ij}}{{r}_{ij}} & \frac{{x}_{ij}^{2}}{{l}_{0} {r}_{ij}} & \frac{{y}_{ij}^{2}}{{l}_{0} {r}_{ij}} & \frac{{z}_{ij}^{2}}{{l}_{0} {r}_{ij}} & \frac{{x}_{ij} {y}_{ij}}{{l}_{0} {r}_{ij}} & \frac{{x}_{ij} {z}_{ij}}{{l}_{0} {r}_{ij}} & \frac{{y}_{ij} {z}_{ij}}{{l}_{0} {r}_{ij}}\end{matrix} ]}^{T} \qquad formula ( 11 )$$
when particle j is a Neumann boundary:
$${p}_{ij} = {[ \begin{matrix}{n}_{x} & {n}_{y} & {n}_{z} & \frac{2 {n}_{x} {x}_{ij}}{{l}_{0}} & \frac{2 {n}_{y} {y}_{ij}}{{l}_{0}} & \frac{2 {n}_{z} {z}_{ij}}{{l}_{0}} & \frac{{n}_{y} {x}_{ij} + {n}_{x} {y}_{ij}}{{l}_{0}} & \frac{{n}_{z} {x}_{ij} + {n}_{x} {z}_{ij}}{{l}_{0}} & \frac{{n}_{z} {y}_{ij} + {n}_{y} {z}_{ij}}{{l}_{0}}\end{matrix} ]}^{T} \qquad formula ( 12 )$$
$${ϕ}_{i j} = \{ \begin{matrix}\frac{{ϕ}_{j} - {ϕ}_{i}}{{r}_{i j}} & j ∈ Internal particle or Dirichlet boundary \\ \frac{\partial {ϕ}_{j}}{\partial {n}_{j}} & j ∈ Neumann boundary\end{matrix} \qquad ( 13 )$$
wherein:
D represents a differential operator vector;
$$\frac{\partial }{\partial x} , \frac{\partial }{\partial y} , and \frac{\partial }{\partial z}$$
represent first-order partial derivatives in x, y, and z directions, respectively;
$$\frac{\partial }{\partial {x}^{2}} , \frac{\partial }{\partial {y}^{2}} , and \frac{\partial }{\partial {z}^{2}}$$
represent second-order partial derivatives in xx, yy, and zz directions, respectively;
$$\frac{{\partial }^{2}}{\partial x \partial y} , \frac{{\partial }^{2}}{\partial x \partial z} , and \frac{{\partial }^{2}}{\partial y \partial z}$$
represent second-order partial derivatives in xy, xz, and yz directions, respectively;
H represents a coefficient matrix of the high-order discretization model;
n⁰ represents an initial particle number density;
M represents a gradient matrix of the high-order discretization model;
bᵢ represents a source term vector of the high-order particle discretization model for particle i;
Pᵢⱼ represents a position gradient vector between particle i and particle j in the high-order discretization model;
xᵢⱼ, yᵢⱼ, and zᵢⱼ represent distances between particle i and particle j in the x, y, and z directions, respectively;
rᵢⱼ represents a distance between particle i and particle j;
nⱼ represents a normal vector of particle j;
nₓ, n_{y}, and n_{z} represent components of the normal vector of particle j in the x, y, and z directions, respectively;
ϕᵢⱼ represents a parameter gradient vector between particle i and particle j in the high-order discretization model;
ϕⱼ represents a parameter scalar value of particle j; and
ϕᵢ represents a parameter scalar value of particle i.

5. The high-precision analysis method for key thermal safety phenomena in a nuclear reactor based on a particle method according to claim 1, wherein the thermal-hydraulic calculation of the key thermal safety phenomena in the nuclear reactor is established based on the key thermal safety phenomena in the nuclear reactor, and calculation steps are as follows:
step 1: calculating incompressible fluid mass and momentum conservation equations as shown in formula (14) and formula (15), wherein operators in the formulas are discretized using the high-order particle discretization model into algebraic equations; viscosity and pressure terms in the momentum conservation equation are solved implicitly, while surface tension and gravity terms are solved explicitly;
$$\frac{D ρ}{D t} + ρ ∇ \cdot u = 0 \qquad formula ( 14 )$$
$$ρ \frac{d u}{d t} = - ∇ P + μ {∇}^{2} u + ρ f + ρ g \qquad formula ( 15 )$$
wherein:
ρ represents density (kg/m³);
u represents a velocity vector (m);
t represents time(s);
P represents pressure (Pa);
μ represents dynamic viscosity (Pa·s);
f represents a surface tension vector (N); and
g represents a gravity acceleration vector (m/s²);
step 2: calculating an energy conservation equation as shown in formula (16), wherein operators in the formula are discretized into algebraic equations using the high-order particle discretization model, and are solved implicitly, and a heat source uses heat density to provide Neumann boundary conditions;
$$ρ \frac{\partial h}{\partial t} = {∇}^{2} {κ}_{T} T + {Q}_{ν} \qquad formula ( 16 )$$
wherein:
h represents an enthalpy (J/kg);
κ_{T} represents thermal conductivity (W/(m·K));
T represents temperature (K);
Qᵥ represents the heat source (W/m³);
radiative heat transfer is contained in the heat source, calculated using formula (17) to formula (18):
$${Q}_{r} = \frac{{h}_{r} {A ( {T}_{i} - {T}_{e n v} )}^{4}}{{l}_{0}^{3}} \qquad formula ( 17 )$$
$${h}_{r} = \frac{{σ}_{s t e f}}{1 / {ε}_{i} + 1 / {ε}_{e n v} - 1} ( {T}_{i}^{2} + {T}_{e n v}^{2} ) ( {T}_{i} - {T}_{e n v} ) \qquad formula ( 18 )$$
wherein:
Qᵣ represents the heat source of the radiative heat transfer (W/m³);
hᵣ represents radiative heat transfer coefficient (W/(m²·K));
σ_{stef} represents a Stefan-Boltzmann constant;
εᵢ represents radiative emissivity of free surface particle i;
εₑₙᵥ represents radiative emissivity of surrounding environment;
Tₑₙᵥ represents temperature of surrounding environment (K);
A represents a radiative heat transfer area (m²);
temperature is calculated using formula (19):
$$T = \{ \begin{matrix}{T}_{s} + \frac{h - {h}_{s}}{{c}_{p}} & h < {h}_{s} \\ {T}_{s} + \frac{( h - {h}_{s} ) ( {T}_{l} - {T}_{s} )}{{h}_{l} - {h}_{s}} & {h}_{s} \leq h \leq {h}_{l} \\ {T}_{l} + \frac{h - {h}_{l}}{{c}_{p}} & {h}_{l} < h\end{matrix} \qquad ( 19 )$$
wherein:
Tₛ and Tₗ represent a solidus temperature and a liquidus temperature (K), respectively;
hₛ and hₗ represent enthalpies (J/kg) corresponding to the solidus temperature and the liquidus temperature, respectively;
cₚ represents Specific heat capacity at constant pressure (J/(kg·K));
a solid fraction is calculated using formula (20):
$$r = \{ \begin{matrix}1 & h < {h}_{s} \\ \frac{{h}_{l} - h}{{h}_{l} - {h}_{s}} & {h}_{s} \leq h \leq {h}_{l} \\ 0 & {h}_{l} < h\end{matrix} \qquad formula ( 20 )$$
wherein:
γ represents the solid fraction;
the analysis of key thermal-hydraulic phenomena applies to gas flow heat transfer and boiling processes; when boiling occurs, due to a significant difference in gas-liquid density ratio, a particle generation method is used to analyze the boiling process; the particle generation method involves generating small-sized particles around a target particle based on an enthalpy rise when the target particle reaches a boiling point, wherein properties of the small-sized particles mimic a gaseous state of the target particle, and mass of the small-sized particles is determined based on a boiling rate; after the small-sized particles are generated, mass of the target particle changes; a particle generation process employs splitting and fusion of the multi-resolution particle method;
for fluid media with large density and viscosity ratios, smoothed density values are calculated as shown in formula (21) and formula (22):
$${ρ}_{g , i} = \frac{1}{{\sum }_{j} {G}_{i j}} {\sum }_{j} ( {ρ}_{j} + \frac{18 {r}_{i j}}{{r}_{e}^{2}} [ \frac{{\sum }_{j} {r}_{i j} {ρ}_{j} {G}_{i j} \times {\sum }_{j} {G}_{i j} - {\sum }_{j} {ρ}_{j} {G}_{i j} \times {\sum }_{j} {r}_{i j} {G}_{i j}}{{( {\sum }_{j} {G}_{i j} )}^{2}} ) ) {G}_{i j} \qquad formula ( 21 )$$
$$〈 μ \cdot {∇}^{2} u 〉 = \frac{1}{{n}_{G}^{0}} {\sum }_{j} \frac{2 {μ}_{i} {μ}_{j}}{{μ}_{i} + {μ}_{j}} ( \frac{36}{{r}_{e}^{2}} + \frac{324 {r}_{i j}^{2}}{{r}_{e}^{4}} ) {u}_{i j} {G}_{i j} \qquad formula ( 22 )$$
wherein:
ρ_{g,i} represents a smoothed density value of particle i (kg/m³);
Gᵢⱼ represents a Gaussian kernel function between particle i and particle j;
ρⱼ represents a density of particle j (kg/m³);
n_{G}⁰ represents an initial particle number density calculated using the Gaussian kernel function; and
μᵢ and μⱼ represent dynamic viscosities of particle i and particle j, (Pa·s).

6. The high-precision analysis method for key thermal safety phenomena in a nuclear reactor based on a particle method according to claim 1, wherein the mechanical deformation calculation of the key thermal safety phenomena in the nuclear reactor is established based on the key thermal safety phenomena in the nuclear reactor, comprising elastic deformation, plastic deformation, creep, thermal expansion, fracture, and solid collision, and calculation steps are as follows:
an overall strain relationship is given by formula (23):
$$[ d ε ] = [ d {ε}^{E} ] + [ d {ε}^{P} ] + [ d {ε}^{C} ] + [ d {ε}^{T} ] \qquad ( 23 )$$
wherein:
[dε] represents total strain;
[dε^{E}] represents elastic strain;
[dε^{P}] represents plastic strain;
[dε^{C}] represents creep strain; and
[dε^{T}] represents thermal expansion strain;
stress-strain calculation is performed using formula (24) to formula (25); a stress-strain relationship of a material is obtained considering a constitutive equation of the material, wherein differential terms in the formulas are discretized using the high-order particle discretization model:
$$\frac{D {u}_{α}}{D t} = \frac{1}{ρ} \frac{\partial {σ}_{αβ}}{\partial {x}_{β}} \qquad formula ( 24 )$$
$${ε}_{αβ} = \frac{1}{2} ( \frac{\partial {u}_{α}}{\partial {x}_{β}} + \frac{\partial {u}_{β}}{\partial {x}_{α}} ) \qquad formula ( 25 )$$
wherein:
u_{α} and u_{β} represents component of a velocity in α and β directions (m/s);
σ_{αβ} represents an αβ component of a total stress tensor (N/m²);
ε_{αβ} represents an αβ component of a total strain tensor; and
x_{α} and x_{β} represent components of a Position in α and β directions (m);
fracture is determined based on stress-strain limits; when stress of a particle exceeds a stress limit or strain of a particle exceeds a strain limit, a relationship between particles is considered broken; only an effect of solid collision forces between particles is calculated, and no mechanical equation calculation within solid is performed.

7. The high-precision analysis method for key thermal safety phenomena in a nuclear reactor based on a particle method according to claim 1, wherein the chemical reaction calculation of the key thermal safety phenomena in the nuclear reactor is established based on the key thermal safety phenomena in the nuclear reactor; the chemical reaction calculation uses two modes, which are based on molecular diffusion and chemical reaction rates, respectively; molecular diffusion is calculated based on formula (26); substance property changes and chemical reaction rates are obtained from chemical reaction equations and a chemical reaction database; particle splitting and particle fusion are employed to obtain particle changes before and after chemical reactions;
$${J}_{A} = - {D}_{A} \frac{d {c}_{A}}{d y} \qquad formula ( 26 )$$
wherein:
J_{A} represents a diffusion flux of component A (mol (m²·s));
D_{A} represents a diffusion coefficient of component A (m²/s); and
c_{A} represents a molar concentration of component A (mol/m³).

8. The high-precision analysis method for key thermal safety phenomena in a nuclear reactor based on a particle method according to claim 1, wherein the neutron physics calculation of the key thermal phenomena in the nuclear reactor is established based on the key thermal safety phenomena in the nuclear reactor; a Boltzmann transport equation using a multi-group approximation S_{N} difference method is given by formula (27):
$$Ω \cdot ∇ ϕ ( r , Ω , {E}_{n} ) + {\sum }_{t} ϕ ( r , Ω , {E}_{n} ) = \int \int {\sum }_{s} ( r , {Ω}^{′} , {E}_{n}^{′} \to Ω , {E}_{n} ) ϕ ( r , {Ω}^{′} , {E}_{n}^{′} ) d {Ω}^{′} {dE}_{n}^{′} + \frac{χ ( r , {E}_{n} )}{4 π} \int \int v {\sum }_{f} ( r , {Ω}^{′} , {E}_{n}^{′} ) ϕ ( r , {Ω}^{′} , {E}_{n}^{′} ) d {Ω}^{′} {dE}_{n}^{′} + \frac{Q ( r , {E}_{n} )}{4 π} \qquad formula ( 27 )$$
wherein:
Ω represents a direction vector;
Ω′ represents another direction vector, which is different from Ω;
ϕ(r,Ω, Eₙ) represents a neutron angular flux density when the input is r,Ω, Eₙ;
ϕ(r,Ω′,Eₙ′) represents a neutron angular flux density when the input is r,Ω′,Eₙ′;
Σᵢ represents a total neutron cross-section;
Q(r,Eₙ) represents neutron source strength;
Eₙ represents neutron energy;
Eₙ′ represents another neutron energy, which is different from Eₙ;
Σₛ(r,Ω′, Eₙ′→ΩEₙ) represents a scattering cross-section;
X(r,Eₙ) represents a fission spectrum;
v represents the number of neutrons released per fission; and
Σ_{f}(r,Ω′,Eₙ′) represents a neutron fission cross-section.

9. The high-precision analysis method for key thermal safety phenomena in a nuclear reactor based on a particle method according to claim 1, wherein the implicit and explicit hybrid solving technique means using explicit solving for the mechanical deformation calculation and the chemical reaction calculation, while using implicit solving for the thermal-hydraulic calculation and the neutron physics calculation; the asynchronous marching algorithm means that implicit solving, with a small time step limit, uses a large time step, and explicit solving, with strict time step requirements, uses a small time step; the time step limit is determined by numerical stability conditions, and different calculation models adopt different time steps, with a multiple relationship between time steps; when all calculations advance to the same time step, information is transferred, and data is updated; implicit solving breaks through the time step limit, and combined with the asynchronous marching algorithm, significantly reduces computational costs and improves analysis efficiency.
